(19) United States
(12) Patent Application Publication
(10) Pub. No.: US 2023/0410225 A1
(43) Pub. Date: Dec. 21, 2023

(54) MOBILE APPLICATION SOFTWARE DISPLAYING IN-PERSON EVENT POSTINGS THROUGH VIDEO OR IMAGE SWIPING

(71) Applicant: Brady Yun-Sheng Lin, Westborough, MS (US)

(72) Inventor: Brady Yun-Sheng Lin, Westborough, MS (US)

(21) Appl. No.: 18/338,197

(22) Filed: Jun. 20, 2023

Related U.S. Application Data
(60) Provisional application No. 63/353,433, filed on Jun. 17, 2022.

(51) Int. Cl. G06Q 50/00

(52) U.S. Cl. CPC G06Q 50/01

(57) ABSTRACT

A system and a method for viewing, curating, and displaying in-person events through videos and photos that are posted by event creators on social media. More specifically, the method discusses multiple ways to access details and participate in an in-person event, by swiping or scrolling through videos and photos that are posted on a mobile application. The method allows users to browse through events, express interest in preferred events, and categorize multiple in-person event postings according to user's preference, with the help of personal mobile electronic devices. The method further enables users to search for events based on time, location, rate, etc. Furthermore, the method of the present invention enables interaction between event creators and people of similar interests. Additionally, the method enables users to invite people through links and messages and thus allow users who create events to be able to advertise events and themselves in an appropriate manner.

### FIELD OF THE INVENTION

The present invention relates generally to the field of mobile applications software and more specifically to the field of mobile applications for displaying in-person events.

### BACKGROUND OF THE INVENTION

People like attending in-person events, such as parties, community events, fundraisers, nightclub events, etc. They like to attend these events with friends and with new people and are looking for new ways to find events and find new friends to go with to these events. Many of the present social networks allow event sharing, but none allow sharing in the manner of the present invention.

An object of this invention is to provide a method for swiping or scrolling through videos and photos that are posted by event creators. Users can express interest and interact with an event through any means of user interface interaction, for example, clicking a button or swiping up on the video or photo. Videos and photos of events are accompanied by important details about the event.

Another object of this invention is to match users to go out to an event together. This will only be provided to those users who have expressed an interest in being matched with other users.

Another object of this invention is to allow users to browse nearby in-person events that users may be interested in.

Another object of this invention is to allow users to use a map-based interface to browse nearby events.

Another object of this invention is to allow users who create events to be able to advertise events and themselves in an appropriate manner.

Another object of this invention is to allow users to browse events that can be disseminated though other users' interests, through mutual social connections between both parties made within the system of the present invention.

Another object of this invention is to allow users to notify other users within and outside of the system of this invention of in-person events they may be interested in attending with the respective party.

Another object of this invention is to allow users to express interest or explicit confirmation of future attendance at an in-person event, as a part of a user interaction within the system.

### SUMMARY OF THE INVENTION

The present invention provides a system and a method for viewing, curating, and displaying in-person events by swiping/scrolling through videos and photos equipped with descriptions that are posted by event creators on this system. More specifically, the method discusses multiple ways to access details and participate in an in-person event, through various methods of browsing through these video/photo event postings. The method not only allows users to browse through event postings in different ways, but also allows users to collect specific event postings for the purpose of future attendance, express interest in events, invite other users or people of these events by notifying them and expressing interest in attending it with them, and confirm attendance in certain events. These actions are possible through the help of a client-side user interface, such as a personal computing (PC) device that connects to a remote server which stores and manipulates the data. This method of the present invention provides a platform with a unique form of social interaction between user accounts that further enhances event browsing and interaction. The present invention also allows for multiple methods of advertising their events towards users within the system, as a result of this social interaction.

### BRIEF DESCRIPTION OF THE DRAWINGS

FIG. 1 is a schematic view showing the overall system of the present invention.

FIG. 2 is a flowchart depicting the overall process of a method, according to a preferred embodiment of the present invention.

FIG. 3 is a flowchart depicting the continuation of the overall process of the present invention.

FIG. 4 illustrates an example view of a swipe card with notification symbols, according to a preferred method of the present invention.

FIG. 5 illustrates an example view of a browse page according to the present invention.

FIG. 6 illustrates an example view of a map page according to the present invention.

FIG. 7 is a flowchart depicting a subprocess of receiving a notification command and providing a notification symbol on a swipe card.

FIG. 8 is a flowchart depicting a subprocess of browsing and displaying the pop-up event page according to the present invention.

FIG. 9 is a flowchart depicting a subprocess of searching for events and displaying a filter collection view.

FIG. 10 is a flowchart depicting a subprocess of displaying and selecting categories on the browse page.

FIG. 11 is a flowchart depicting a subprocess of possible interactions on a ‘personal collection of events page’.

FIG. 12 illustrates an example view of an ‘personal collection of events page’, according to the present invention.

FIG. 13 is a flowchart depicting a subprocess of possible actions on a social page, according to the present invention.

FIG. 14 is a flowchart depicting a subprocess of possible interactions on a personal profile page.

FIG. 15 is a flowchart depicting a subprocess of posting an event, according to the present invention.

FIG. 16 illustrates an example view of the people's page, according to the present invention.

FIG. 17 illustrates an example view of the personal profile page, according to the present invention.

FIG. 18 is a flow diagram of the overall process of the present invention.

FIG. 19 is a continuation of the flow diagram of the present invention.

FIG. 20 is a continuation of the flow diagram of the present invention.

FIG. 21 is a continuation of the flow diagram of the present invention.

FIG. 22 is a continuation of the flow diagram of the present invention.

FIG. 23 is a continuation of the flow diagram of the present invention.

### DETAILED DESCRIPTIONS OF THE INVENTION

All illustrations of the drawings are for the purpose of describing the selected versions of the present invention and are not intended to limit the scope of the present invention.

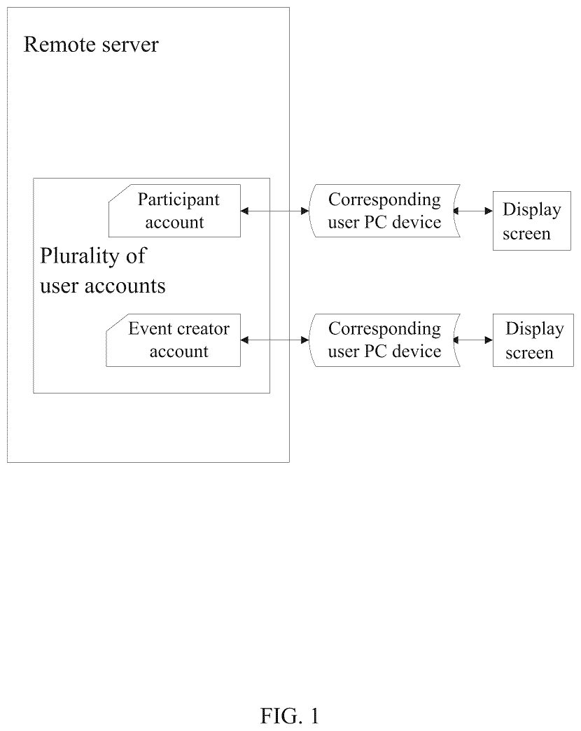

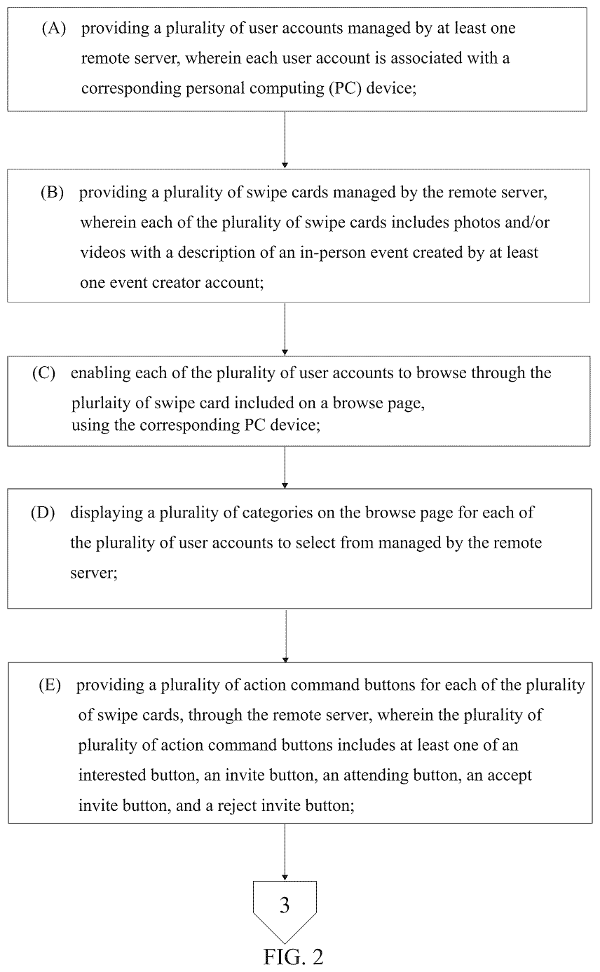

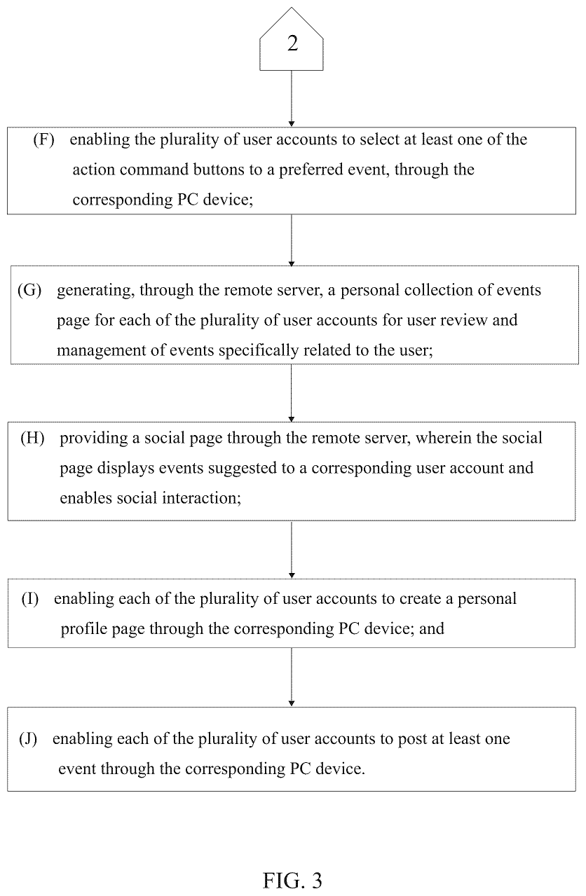

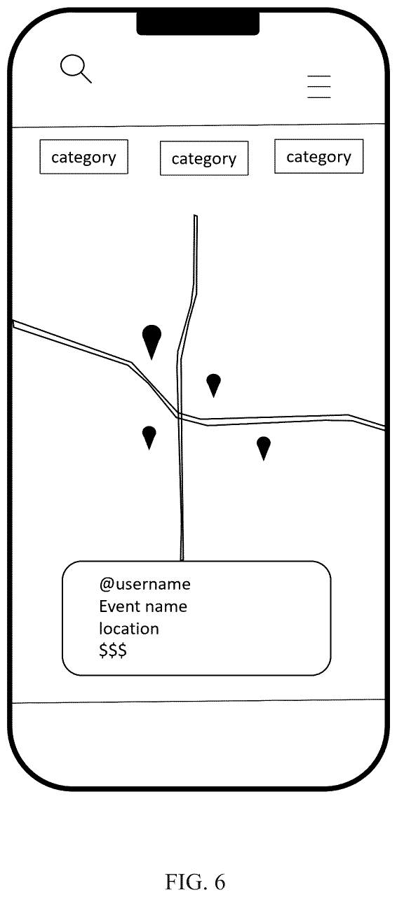

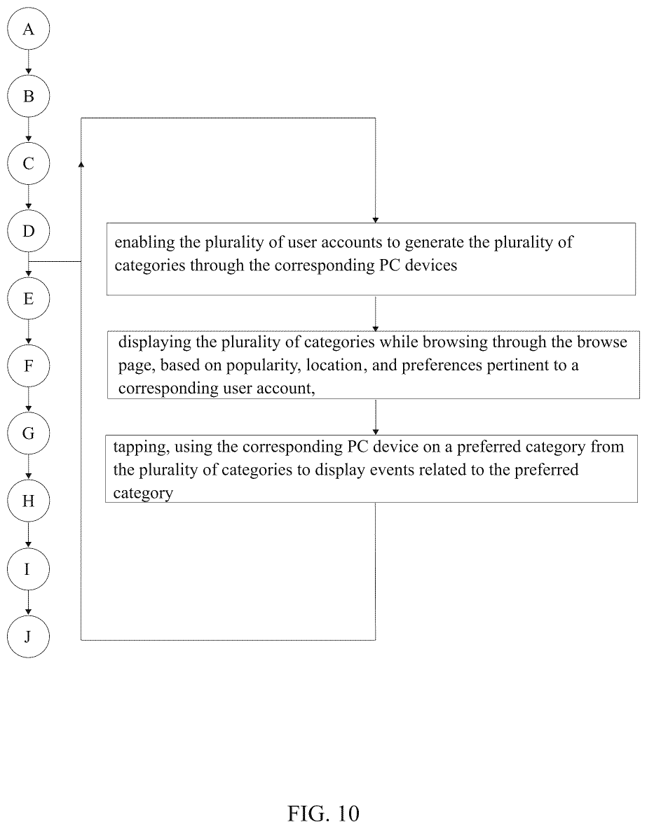

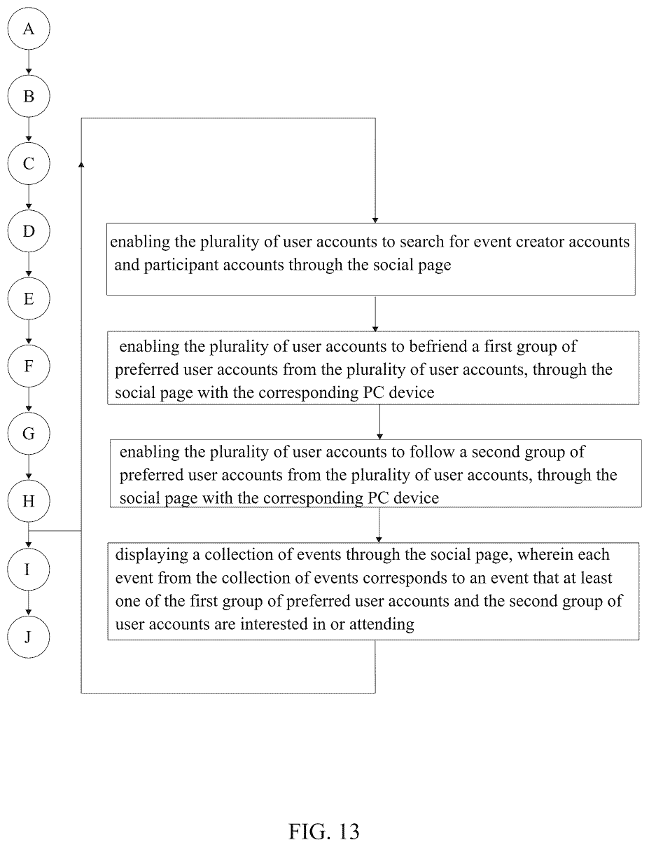

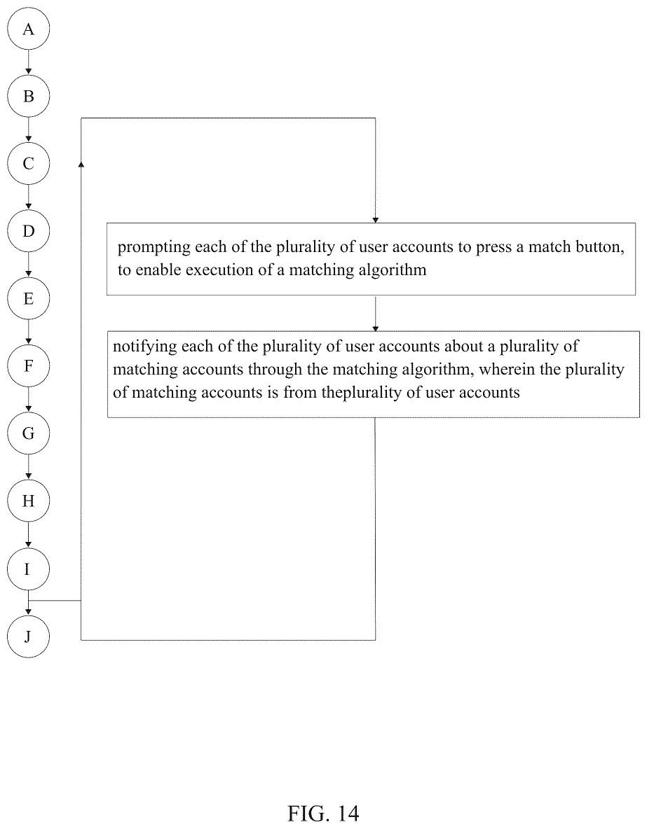

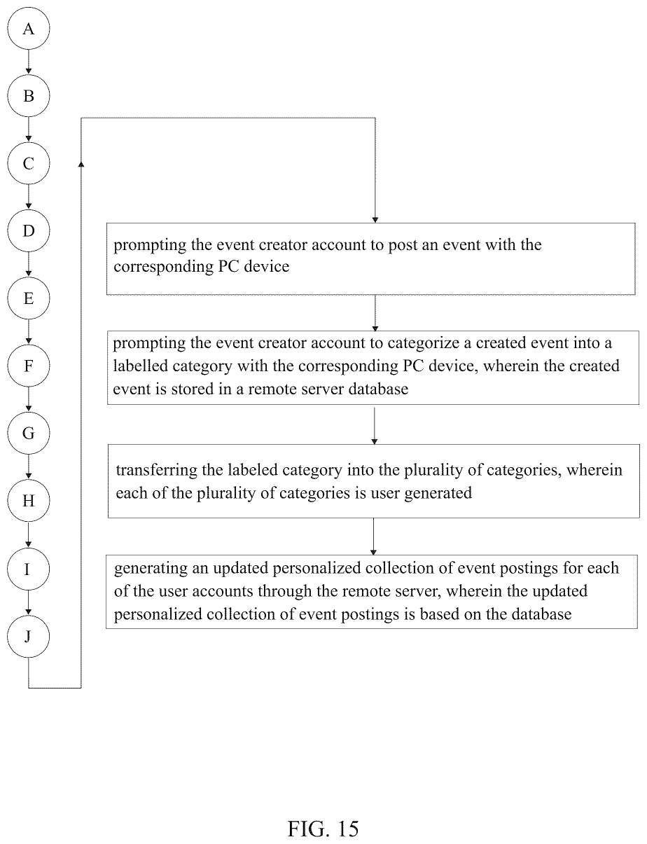

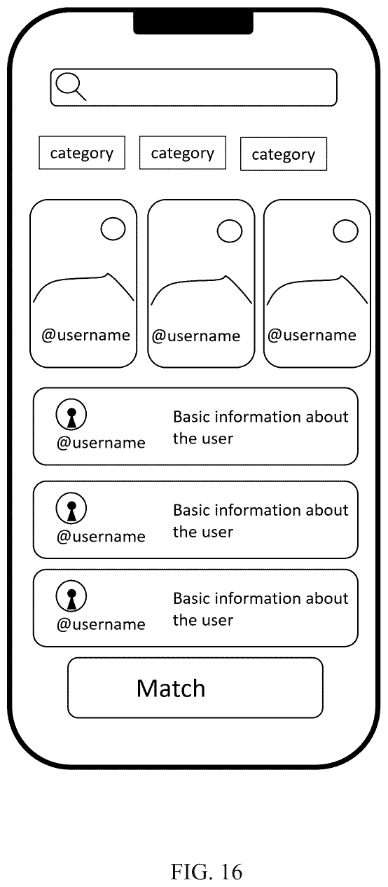

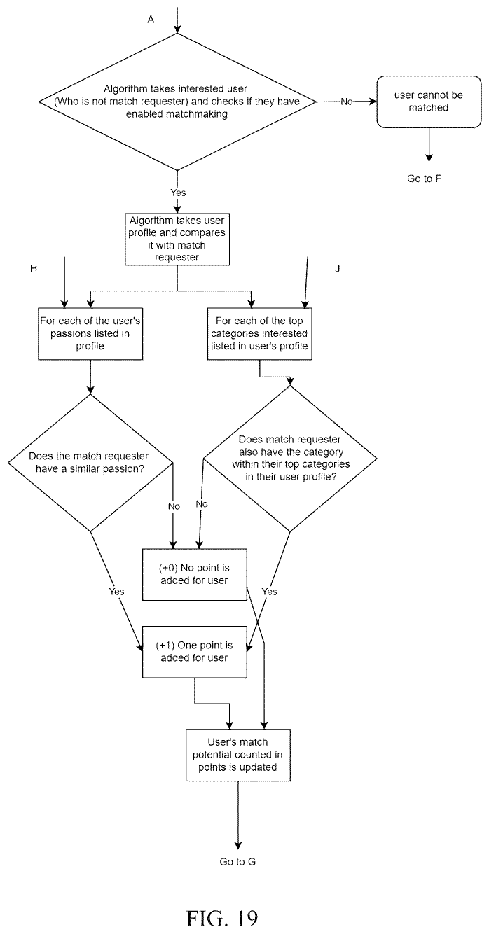

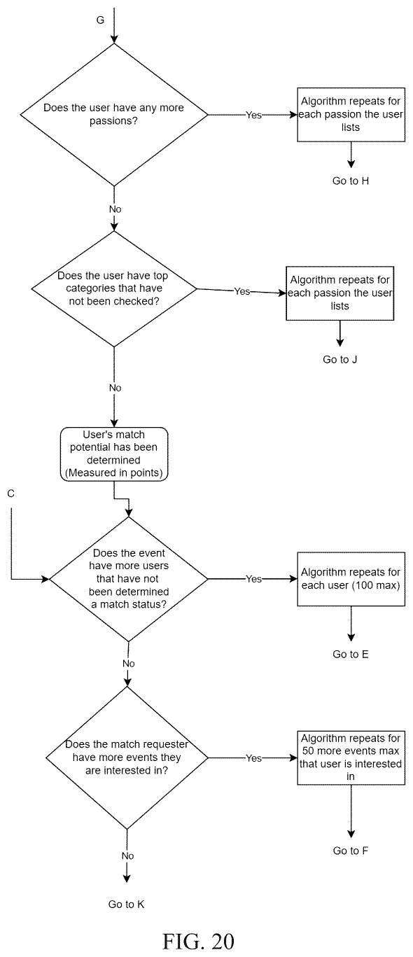

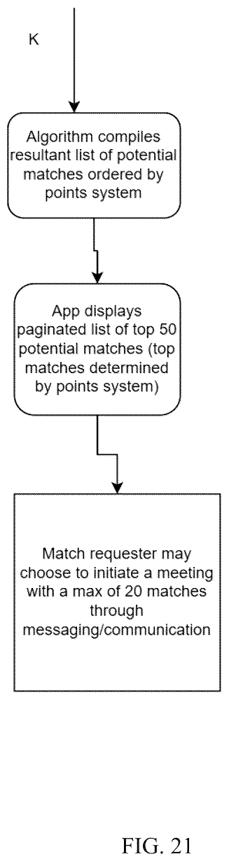

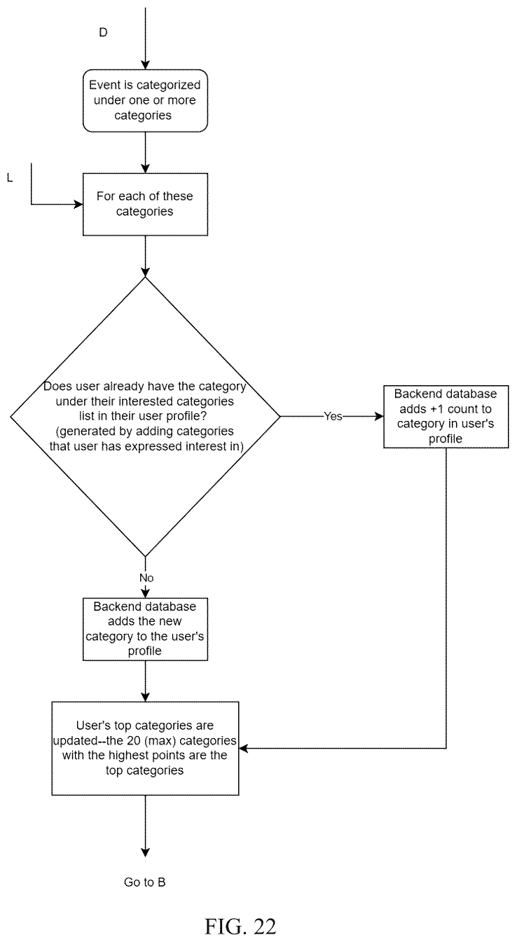

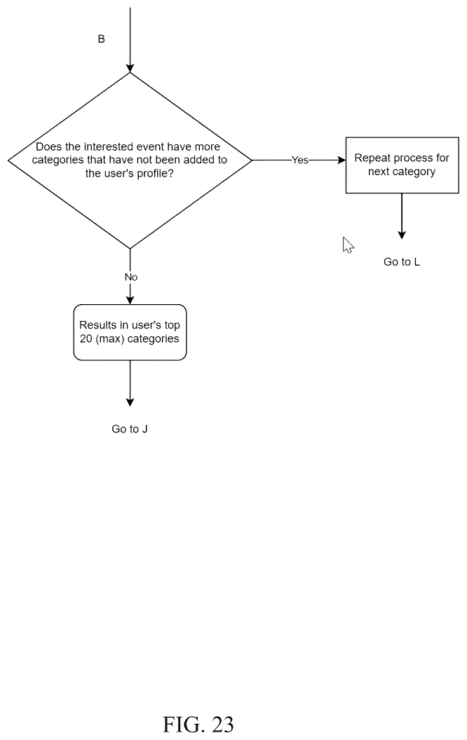

The following description is in reference to FIG. 1 through FIG. 23. As can be seen in FIG. 1, the system used to implement the method of the present invention is provided with a plurality of user accounts managed by at least one remote server (Step A). Each of the plurality of user accounts is associated with a corresponding user personal computing (PC) device. In the preferred embodiment, the plurality of user accounts may be designated as at least one of an event creator account and a participant account. More specifically, each of the plurality of user accounts is tied to a single user who is able to interact, participate, and operate the corresponding user PC device while implementing the present invention. In other words, each of the plurality of user accounts has the ability to elect to be an event creator account, a participant account, or both. The user interface (for example, a display screen of the corresponding PC device) of the client-side application provides people with the ability to create a user account, and then use that user account to post in-person events and the browse through them. The corresponding user PC device allows a user to interact through the present invention and can be, but is not limited to, a smartphone, a laptop, a desktop, or a tablet PC. To that end, the present invention works on operating systems, mobile applications, and/or may be embedded into websites. The remote server is where the user account and in-person event postings are stored and is also used to facilitate data transformations and interactions between the plurality of user accounts and event postings.

To accomplish the above-mentioned functionalities, the system used to execute the method of the present invention provides several pages with various methods of browsing, collecting, and interacting with event postings and other user accounts. As mentioned, the present invention is also equipped with the capability of posting events, as well as creating and manipulating a personal user account. This is all done through a means of communicating, manipulating, and retrieving data to and from the remote server. The functionalities of browsing, collecting, and interacting with event postings on the client-side application of the system described, a core process of the client side application of present invention entails a universal system of displaying event postings, any time a collection of in-person event postings, such as a list of events, as opposed to a singular event, is required to display on a specific page of the present invention. This collection of events is displayed through a collection of “swipe cards,” a term used to describe the user interface format for displaying a photo/video event posting along with its description. To that end, the overall method of the present invention comprises providing a plurality of events managed by the remote server (Step B). This plurality of events is retrieved from the remote server by the corresponding user PC device running the client-side application, and thus displayed on the application in the format of swipe cards. Preferably, each of the plurality of swipe cards includes photos and/or videos with a description of an in-person event created by at least one event creator account. These individual swipe cards that correspond to individual events are always part of a larger collection of events a user may swipe through on different pages of the application. More specifically, in each swipe card, there is a preview of a singular video or photo, wherein this preview may be darkened and have an overlay of text containing the creator's username, the event name, basic details such as price range and distance from user, a number of users interested in the event, a number of people invited to the event, a number of people attending the event, a start and end time, an address/geographic location, and a brief description of the event.

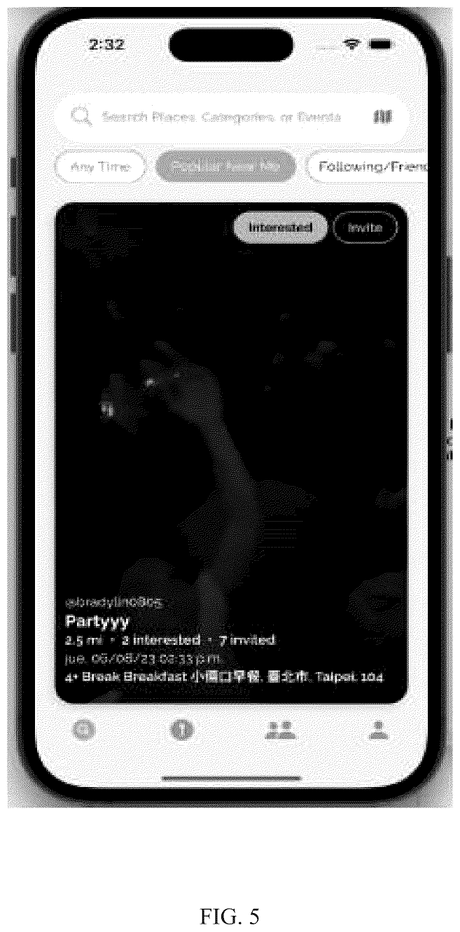

The overall method continues by enabling each of the plurality of user accounts to browse through the plurality of swipe cards included on a browse page using the corresponding PC device (Step C). As shown in FIG. 5, the browse page or the main swipe page is for users to browse through nearby events they may be interested in. In the preferred embodiment, the event creator account is associated with a user who creates and posts details of an event through the corresponding PC device. Further, the participant account is associated with a user who has access to view the details, browse and search through various swipe cards representing event postings, and express interest in the plurality of events posted on the browse page. Thus, the plurality of user accounts may browse through events, by swiping or scrolling through videos and photos on the browse page, that are posted by event creators.

Continuing with the preferred embodiment, the overall method comprises displaying a plurality of categories on the browse page managed by the remote server (Step D). Preferably, each of the plurality of categories provides a list of events matching with a corresponding category, wherein the corresponding category is from the plurality of categories. The plurality of categories are alphanumeric words or phrases that are 50 characters or less, that may describe a way to categorize an event within the context of current social trends. Preferably, the plurality of categories is displayed within a collection view on the browse page. More specifically, the user-generated collection of categories, which can reach a maximum of 50 on the browse page, are populated on the main swipe page (browse page) to display the most popular categories within the vicinity (+−2 degrees latitude and longitude) of a user at the specific time the user opens the application. The most “popular” categories are dictated by an algorithm that finds the categories with the highest number of events posted within the aforementioned vicinity to said user. This algorithm is executed immediately after the user opens the application, thus returning the most “popular” categories at this specific time. This implies that certain categories may change in “popularity” over time, as new events are created with different categories over time. This process is generated as a result of an API call to a remote server which then returns these categories. Depending on which category is selected, active events that follow the criteria of this category are retrieved from the remote server and displayed on the main swipe page of the PC device. An active event is an event that is yet to happen or ongoing. If the time of an event has passed, the post will automatically become inactive or be removed from the event feed.

In order to accomplish the functionalities of user interactions with event postings, a core process of the present invention must be established. In the present invention, users may interact with an event posted on the event postings browse page in multiple ways. Thus, the overall process functions by providing a plurality of action command buttons for each of the plurality of swipe cards, through the remote server, wherein the plurality of action command buttons includes at least one of, an interested button, an invite button, an attending button, an accept invite button, and a reject invite button (Step E). These action command buttons that are available for participant users are individually enabled by the event creator upon event creation or upon editing the event. In other words, the swipe card also includes the “Interested,” “Invite,” “RSVP”, and “Accept Invite”/“Decline Invite” buttons, should they be enabled by the event creator, or necessitated by the condition of the event viewed in relation to the user viewing it. These buttons are specific methods of user interaction with events. To that end, the overall method comprises enabling the plurality of user accounts to select at least one of the action command buttons to a preferred event on the browse page, through the corresponding PC device, wherein the preferred event is from the plurality of swipe cards (Step F). An “Interested” button allows a user to show they are interested in the event. The present invention is detailed in this way, but users are not limited to expressing interest by this sole means of user interaction. The “invited” button enables the plurality of user accounts to share events with each other so that they may be alerted to the existence of this event and be notified of the other party's desire for them to attend this event with them. This translates into an “Invite” button on all events (that have enabled inviting) where users may tap on that button, receive a list of “friended” users on the app, and tap “Invite” on to any or all of them. In each event, the “Attending” function may be enabled and/or the “Interested” function may be enabled. The “Attending” function, unlike the “Interested” function, is a way for users to explicitly state to the event creator they will be attending the event, contrary to the “Interested” function, where user accounts simply state that they have interest in the event but will not necessarily attend the event in actuality.

The overall method of the present invention continues by generating, through the remote server, a personal collection of events page for each of the plurality of user accounts for user review and management of events specifically related to the user (Step G). The personal collection of events page displays a collection of all the live events the user is “Interested” in, the user is “Invited” to, and all the live events the user is “Attending”. Additionally, there is a fourth collection of events, which are the events the user themselves have created, and may be labeled as “My Events”. In other words, the personal collection of events page comprises at least one of a collection of live events that a corresponding user account is interested in, a collection of events that the corresponding user account is invited to, a collection of events that the corresponding user account is attending, and a collection of events that the corresponding user account has created. The collections of events are displayed in the format of “swipe cards,” or the universal format across the application of displaying a plurality of events mentioned above.

It is an aim of the present invention to enable interaction between the plurality of user accounts. To that end, the overall process of the method continues by providing a social page through the remote server (Step H). Preferably, the social page displays events suggested to a corresponding user account and enables social interaction, wherein the corresponding user account is from the plurality of user accounts. The method allows different ways of communication between the plurality of user accounts based on the selections and the approvals that the user enters with their corresponding PC devices.

Continuing with the preferred embodiment, the overall process comprises enabling each of the plurality of user accounts to create a personal profile page through the corresponding PC device (Step I). In other words, a main profile page is additionally created, which is the public display of certain elements of a user account, including the user's created events, an optional “highlights” section, their total number of followers, following, friends, and events, profile picture, name, username, and personal details about themselves that they may like to be included.

In order to accomplish the functionalities of user interactions with event postings, a core process of the present invention must be established. In the present invention, each user account is equipped with the functionality of posting events. To that end, the overall method continues by enabling each of the plurality of user accounts to post at least one event through the corresponding PC device (Step J). The process of posting events constitutes of user inputting information such as the name, start and end time, location, age limit, description, price of attendance, and website.

A more detailed description of the present invention continues.

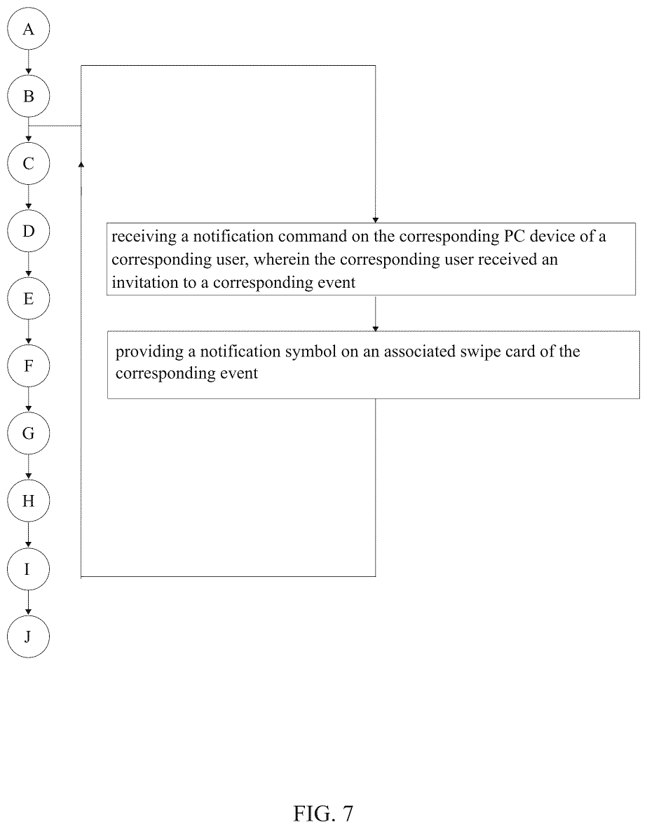

In reference to FIG. 7, a sub-process of the present invention comprises the steps of receiving a notification command on the corresponding PC device of a corresponding user, wherein the corresponding user is from the plurality of user accounts who received an invitation to a corresponding event. In other words, the receiving party of an invitation will receive a push notification, and/or an in-app notification, and this event will show up in their list of events that they are Invited to (located on the “personal collection of events page”). Additionally, every time they encounter this event on the app, there will be a ribbon on the top of the video/photo that says, “X (the inviter) has invited you to this event”. Thus, the sub-process continues by providing a notification symbol on an associated swipe card of the corresponding event, wherein the notification symbol is the ribbon. Further, the swipe card includes a ribbon displaying information about another users' relation to the specific event and the viewing user, should the displayed event necessitate this ribbon of information. This can include situations such as if the referenced user invited the viewing user to the event, or if the referenced user is attending the event and the referenced user and the viewing user engage in specific social interactions on the system. Preferably, there are two buttons below this ribbon or notification symbol that say “Accept Invite” or “Decline Invite” on the swipe card, or on the event page, wherein the two buttons will be located at the bottom of the screen. In other words, the notification symbol also reveals an accept invite button and a decline invite button associated with the notification symbol.

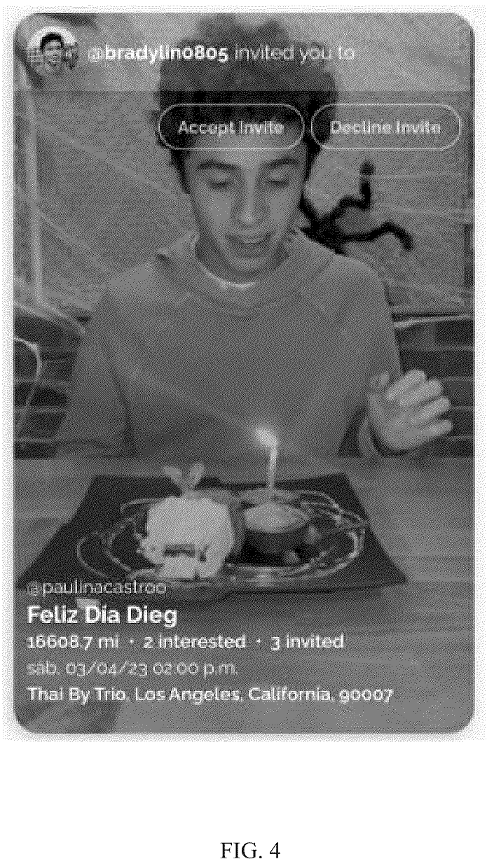

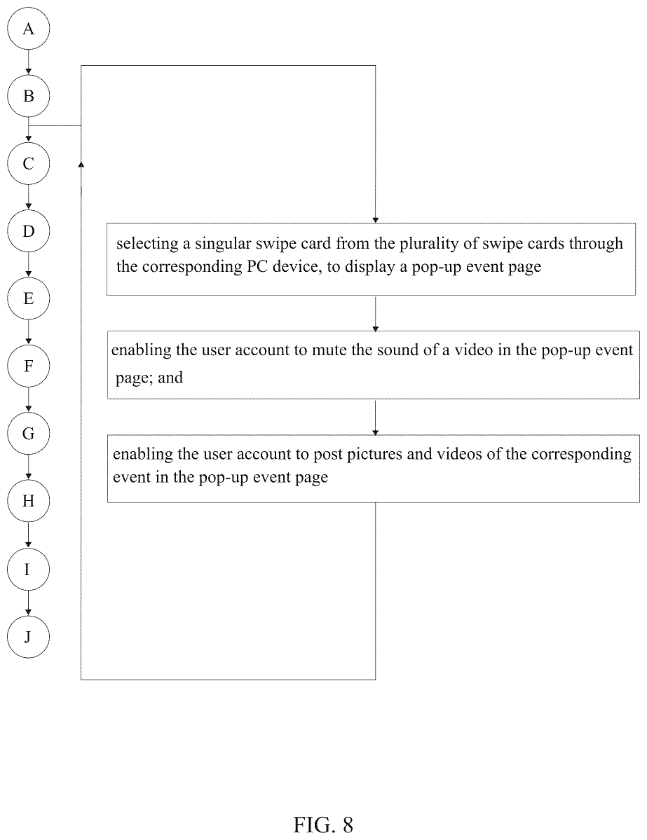

In reference to FIG. 8, a sub-process of the present invention comprises selecting a singular swipe card from the plurality of swipe cards through the corresponding PC device, to display a pop-up event page. Preferably, the pop-up event page displays details and media of the corresponding event illustrated by the previously selected swipe card. FIG. 4 illustrates an example of a pop-up event page for the present invention. If the swipe card or cell in FIG. 5 is tapped, the pop-up event page shows the necessary information to attend the event. This page shows a single compiled video or photo in full aspect ratio and not dimmed. The sub-process continues by enabling the user account to mute the sound of a video in the pop-up event page. In other words, if a video is shown, and sound is also played, users additionally have the option to mute the sound of the video. This page lists details such as event creator, event name, price range of the event, distance, the number of people interested, invited and/or attending, the start and end time, the location of the event, a description of the event and price of the event. Further, the sub-process continues by enabling the user account to post pictures and videos of the corresponding event in the pop-up event page. More specifically, on this page, users can post photos and videos with a description of experiences at the event. Event creators can use these photos and videos to make a “highlights” section of the event profile (explained in “Profile” page). There is also a questions and answers section where the event creator can communicate with interested users. This page also may have one or more of the following: an “Interested” button, an “Invited” button, and/or an “Attending” button, and additionally an “Accept Invite”/“Decline Invite” button if needed.

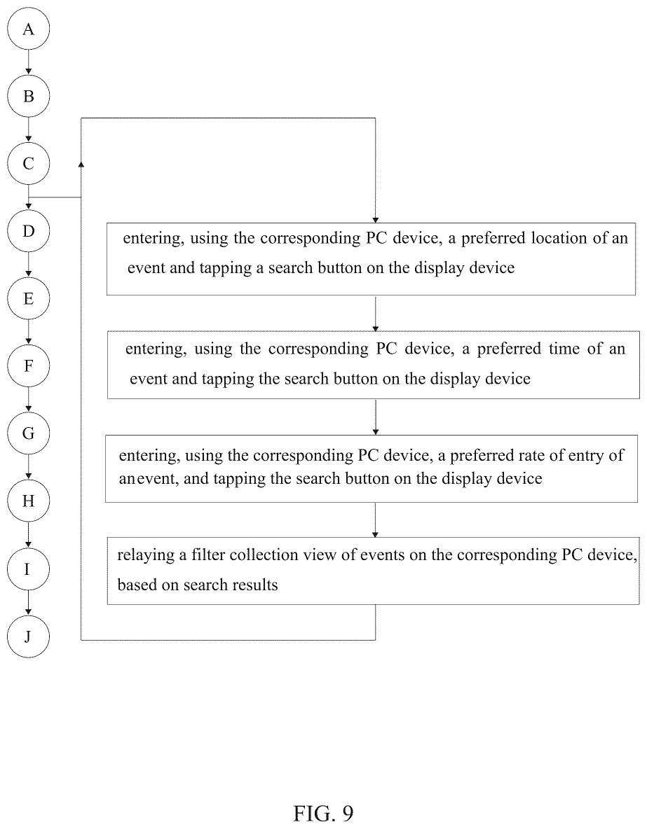

An objective of the present invention is to allow users to browse nearby in-person events that users may be interested in, as well as allow users to search locations, categories or specific events using key words that are input into the client-side application. A search button is used to search places, categories, or events that may help filter the swipe cards or find a specific event. Users may specifically search for categories they would like to explore. Additionally, results can be filtered based on a searched location. For example, user A has the option to search for music shows within a specific area or location. A filter collection view of the browse page provides options for filtering events that are output as the result of a search. More specifically, filters are for time, location, price, etc. Accordingly, as seen in FIG. 9, a sub-process of the present invention comprises the steps of entering, using the corresponding PC device, a preferred location of an event and tapping a search button on the display device. For example, if a user A wants to search for events in Los Angeles, the user A types Los Angeles in the search bar and hits the search button to display events happening in Los Angeles. The sub-process continues by optionally entering, using the corresponding PC device, a preferred time of an event and tapping the search button on the display device. Further, the sub-process comprises optionally entering, using the corresponding PC device, a preferred rate of entry of an event, and tapping the search button on the display device. For example, there may be entry rates for many events, and the user A may be looking for a free event. Subsequently, the sub-process relays a filter collection view of events on the corresponding PC device, based on the search results. The filter collection view is used to display various categories used to additionally filter out events. The user can choose at least one of these categories and the events displayed on the swipe cards will only show events related to those categories. A searched location can also be in this collection view.

According to the method of the preferred embodiment, the main browse page may display a map where users can drag and tap on markers that will display smaller swipe cards with basic information and media representing the event. To that end, searching for a preferred event feed includes providing a map-based interface to search for events, wherein the preferred event feed is from the plurality of swipe cards. The method of browsing through events with the map is the same as the aforementioned method of browsing through events with the main swipe page, with the addition of a draggable map which contains markers, that a user can then select to reveal a smaller swipe card of an event. In other words, searching for a preferred event feed includes providing a map-based interface to search for events.

According to the present invention, each of the plurality of categories are user created and each category may be tapped to filter out events. To that end, a subprocess of the present invention comprises the steps of enabling the plurality of user accounts to generate the plurality of categories through the corresponding PC devices. Further, the plurality of categories is arranged on the browse page in such a way that user preferences and popularity of events near a user's location at the time the app is being opened are considered. Accordingly, the subprocess continues by displaying the plurality of categories while browsing through the browse page, based on popularity, location, and preferences pertinent to a corresponding user account, wherein the corresponding user account is from the plurality of user accounts. In other words, a relevant set of categories are displayed for each of the plurality of user accounts on the browse page, wherein the relevant set of categories is from the plurality of categories. More specifically, a relevant category such as a “Popular near me” category, returns the events with the highest count of interested or attending users within the vicinity (+−2 degrees latitude and longitude) of the user. The subprocess continues by tapping, using the corresponding PC device on a preferred category from the plurality of categories to display events related to the preferred category. Depending on which category is selected, active events that follow the criteria of this category are retrieved from the remote server and displayed on the main swipe page of the PC device. An active event is an event that is yet to happen or ongoing. If the time of an event has passed, the post will automatically become inactive or be removed from the event feed.

According to the present invention, the browse page includes a recommended section. Preferably, the “Recommended” section is a collection of events that is generated by an algorithm that produces a personalized feed of events to swipe through.

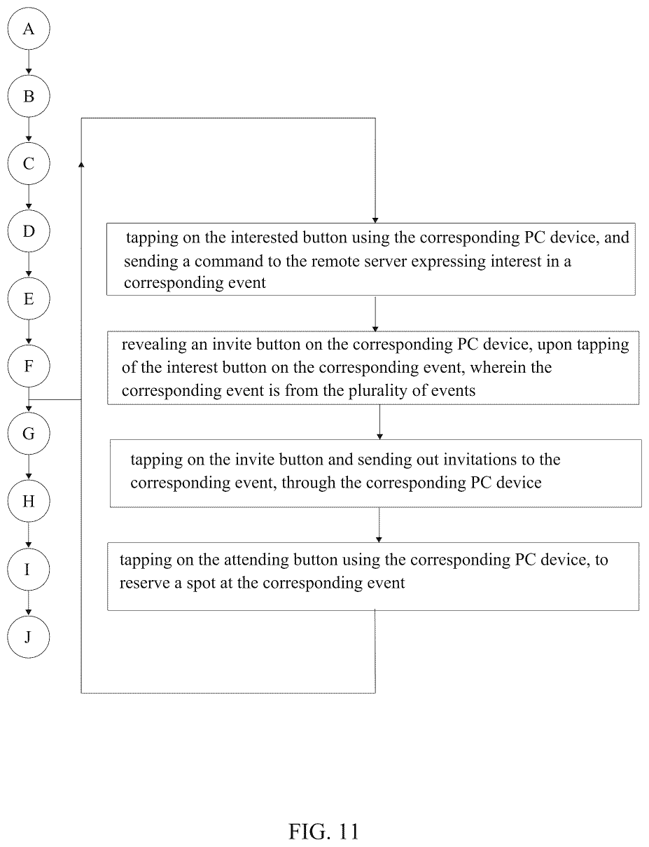

As part of the user-event interactions of the present invention, the user account is provided with the plurality of action command buttons, wherein the plurality of action buttons can be conditionally enabled or disabled by the corresponding event creator account. To that end, and in reference to FIG. 11, a sub-process of the present invention includes tapping on an ‘interested’ button using the corresponding PC device and sending a command to the remote server expressing interest in a corresponding event. When the “Interested” button is tapped, an “Invite” button is revealed which allows the user to invite confirmed “friends” on the app to join the event. In other words, the sub-process continues by revealing an invite button on the corresponding PC device, upon tapping of the interest button on the corresponding event, wherein the corresponding event is from the browse page. Further, the sub-process continues by tapping on the invite button and sending out invitations to the corresponding event, through the corresponding PC device. The invitation may further include sending out texts or sharing a link to invite people who haven't joined the app to download the app and express interest in the event. Furthermore, the sub-process continues by tapping on the attending button using the corresponding PC device, to reserve a spot at the corresponding event. This is for events where the event creator specifically requested to keep track of confirmed attendees. The Interested button may be displayed in the same way; this button would be present on events where the event creator specifically requested to keep track of users who express interest in the event. On the app, this functionality is present on the swipe card or the event page itself. Preferably, on the swipe card, this would be at the top right corner of the swipe card.

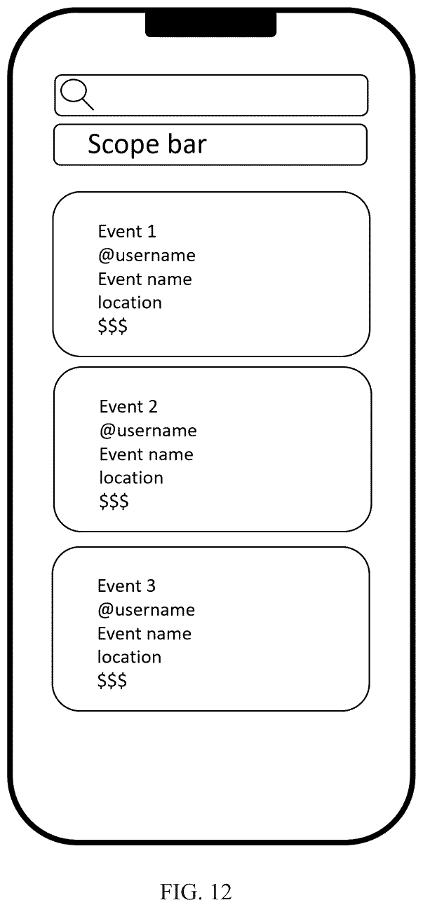

According to the preferred embodiment, the personal collection of events page is provided as a category in the manner mentioned above. FIG. 12 illustrates an example of a page that lists events that constitute a collection of events that are specifically related to the using party's user account, on the client side of the application. This collection is only visible to said user. As previously described, the personal collection of events page displays a collection of all the live events the user is “Interested” in, the user is “Invited” to, all the live events the user is “Attending”, and the events the user themselves have created. The collections of events are displayed in the format of “swipe cards,” or the universal format across the application of displaying a plurality of events mentioned above. Accordingly, the present invention includes providing a scope bar on the ‘personal collection of events page’, to differentiate between these various collections of events. Additionally, there is a search bar to search through each of the collection of events.

In order to accomplish certain functionalities of browsing events and inviting users on the client-side application of the system described, a core process of the present invention must be established. The present invention allows for two primary social interactions between users: “friending” and “following.” “Friending” is a two way social relationship formed between users, in which one user sends a request to become “Friends” with another user and the other user must accept said request to become confirmed “friends.” “Following” is a directional relationship, in which a user may “follow” another user, but the recipient user does not confirm nor deny, and has the choice of whether to reciprocate. Accordingly, a subprocess of the overall method comprises the steps of enabling the plurality of user accounts to search for event creator accounts and participant accounts through the social page. The subprocess continues by enabling the plurality of user accounts to befriend a preferred user account through the social page on the corresponding PC device, wherein the preferred user account is from the plurality of user accounts. Further, the subprocess continues by enabling the plurality of user accounts to follow the preferred user account through the social page on the corresponding PC device. More importantly, the subprocess displays a collection of events through the social page, that the preferred user account is interested in or attending, a plurality of users which have followed the same process as and further enables the plurality of user accounts to browse through the collection of events.

According to the method of the present invention, the social page allows people to browse event creators and other users. A subprocess of the overall method comprises the steps of enabling the plurality of user accounts to search for event creator accounts and participant accounts through the social page. The subprocess continues by enabling each of the plurality of user accounts to befriend a first group of preferred user accounts from the plurality of user accounts, through the social page with the corresponding PC device. In other words, each of the plurality of user accounts may befriend one or more people from the plurality of user accounts, and the first group of preferred user accounts constitutes all such user accounts that any user has befriended. Similarly, any user account from to the plurality of user accounts may follow a different group of people from the plurality of user accounts through the social page. To that end, the subprocess continues by enabling the plurality of user accounts to follow a second group of preferred user accounts from the plurality of user accounts, through the social page with the corresponding PC device. The second group of user accounts may contain users from the first group of user accounts or may contain an entirely different set of users from the plurality of user accounts as well.

Additionally, the subprocess of the social page comprise the steps of displaying a collection of events through the social page, wherein each event from the collection of events corresponds to an event that at least one of the first group of preferred user accounts and the second group of user accounts are interested in or attending. In other words, the social page enables a user to browse through events that said user's “friends” or users that said user “follows” are interested or attending. For example, if a user X is “friends” with a user Y, when user Y taps “interested” on an event A. This event A will show up in the collection of events displayed on user X's social page, and this event A will additionally have a notification that says that user Y is interested in this event A. This is shown as a notification symbol on the swipe card associated with event A. Additionally, user Y may choose in their user settings whether to display events they select “Interested” or “Attending” on, on their Friends' social page. Furthermore, if a user “follows” a user Y, user X may also view the events that user Y has tapped interested or attending on in the Social Page, given that user Y enables this functionality in their user settings.

According to the present invention, the method includes various buttons and categories that help with matching two or more users from the plurality of user accounts together to attend an event, located on the personal profile page. This is based on an event that all users are simultaneously interested in, and based on personal interests, personalities, passions, and hobbies that they list on their personal profile. A “match” button will execute an algorithm that searches for people with similar interests and interests in similar events. To that end, a subprocess of the overall method comprises the steps of prompting each of the plurality of user accounts to press a match button, to enable execution of an algorithm, wherein the matching algorithm searches for user accounts from the plurality of user accounts, with similar interests and interests in similar events. In other words, the algorithm searches for user accounts with similar interests and interests in similar events. Users who wish to use the matchmaking feature must have agreed to be available for matching. Each user must express interest in one or more of the same events that the other user is also interested in in order to make a match. Further, the sub-process continues by notifying each of the plurality of user accounts about a plurality of matching accounts through the matching algorithm, wherein the plurality of matching accounts is from the plurality of user accounts. In other words, the “match” button will pair and notify the user of a match and will optionally initiate a meeting between the users at an event in which users are mutually interested. If each user has listed similar qualities on their profile to the other user's profile, this puts these users at higher priority of being matched together. If each user has similar interests, then the users are at higher priority of being matched. Users have the option of choosing among other users to go to an event the users are mutually interested in, or users may ignore matches.

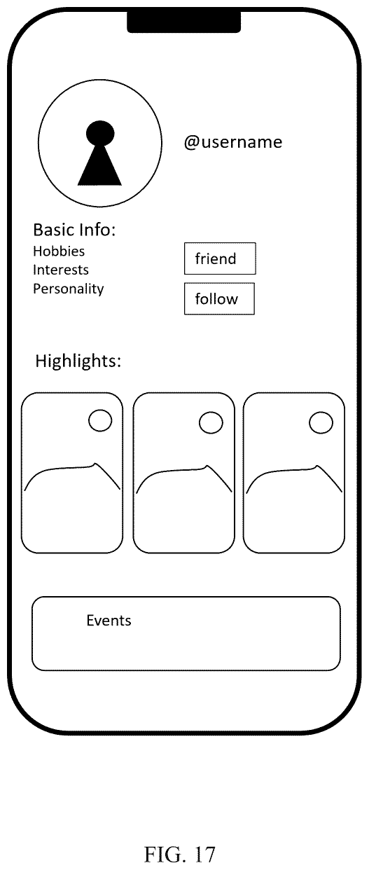

FIG. 17 illustrates an example of a view of a personal profile page which allows event creators to display “highlights” of events the creator has posted, which can be from photos and videos that the creator has added, or photos and videos posted about previous events. In other words, the plurality of user accounts displays highlights of events through the personal profile page, wherein highlights includes photos and videos that the corresponding user account has added in the personal profile page. There is also a follow/friend button where users can friend or follow other users, with the user electing to enable whether users should be able to friend them, follow them, or both. There is an optional “highlights” section for event creators to display highlight videos and photos of their past events or what is notable about past events. An “events” section displays past events of event creators with details about the event.

In the present invention, each user account is equipped with the functionality of posting events. Accordingly, a subprocess of the present invention comprises the steps of prompting the event creator account to post an event with the corresponding PC device. The user may toggle settings influencing how the event will be displayed, such as enabling the “Interested” button, to track a list of people who express interest on the event, enabling attendance, to track a list of people who confirm future attendance on the event, and enabling inviting, which controls whether users may participant users may “Invite” other users to the event. Creating users may also toggle whether they want their event to be “Private,” rendering the event invite-only, in which it is not displayed on any public event pages, and toggle whether they want to enable participant users to post “Highlights,” or participant users' photos and videos from attending the event. An additional functionality users may have in the creation of their events is to append categories to categorize their event within the context of the server data. Accordingly, the subprocess continues by prompting the event creator account to categorize the posted event into a labeled category with the corresponding PC device, wherein the posted event is stored in a remote server database. In other words, each time an event is created, the application prompts the event creator to categorize the event as a party, concert, school club event, school event, etc., which then provides at least one category to label the event in the application database system. These categories are completely user-generated, or in other words, every new category created within the system of the present invention is generated by an event creator who created that category in the process of creating an event. Accordingly, the subprocess continues by transferring the labeled category into the plurality of categories, wherein each of the plurality of categories is user generated. These categories are alphanumeric words or phrases that are 50 characters or less, that may describe a way to categorize an event within the context of current social trends. In the preferred embodiment, categories are primarily displayed and ordered by their popularity within the local vicinity at time the user opens the app. However, categories that the user has favorited can have additional influence on which of the popular categories are displayed first, omitted, etc. In other words, the original/popular categories may be narrowed down, through a backend process that enables the categories to be ordered based on the intentional user selections and/or omissions. Furthermore, the present invention may comprise a backend data collection process that includes category preferences data of each of the plurality of user accounts, being collected and carried through the remote server. Based on this data on category preferences/selections/omissions, the plurality of categories displayed on the browse page will be updated each time a user opens the application.

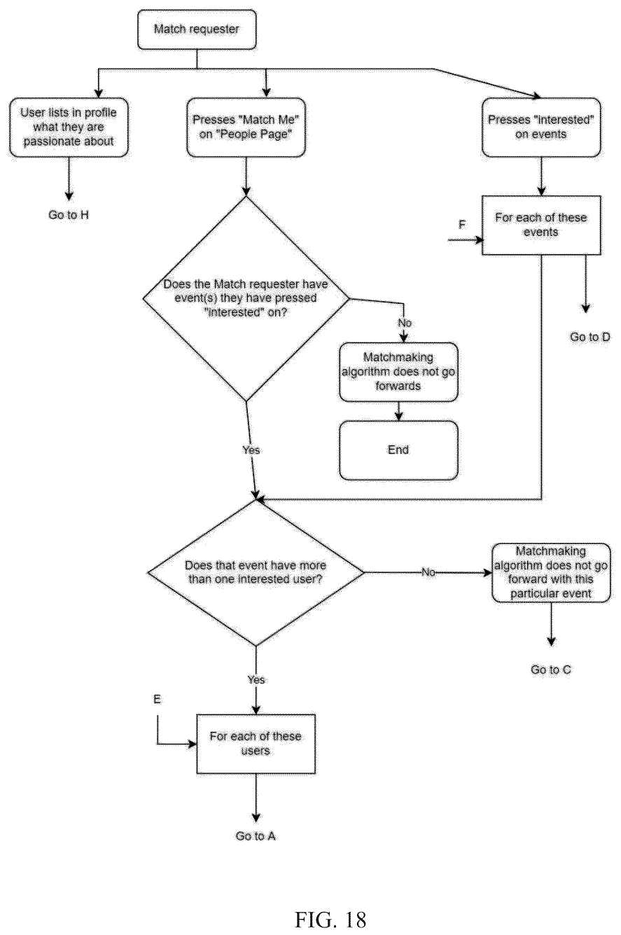

FIG. 18 through FIG. 23 represent a flow diagram of the match algorithm, according to the preferred method of the present invention. A match requester presses a “Match Me” button located somewhere on the personal profile page. If the match requester does not have one or more events that they have pressed “Interested” on, then the matchmaking algorithm does not go forward and the program ends. If, however, the match requester does have events that they have pressed “interested” on then if the event has more than one interested user then for each of these users the algorithm takes the interested user, who is not the match requester, and checks to see if they have enabled matchmaking. If matchmaking is not enabled, then the user cannot be matched and another interested user is checked. If matchmaking is enabled, then the algorithm takes the user profile and compares it with the match requester. For every similar passion and top category, one or more points is added for the user. This is repeated for all passions and top categories. For example, the algorithm repeats for each user that is interested in the event that has not been determined a match status, up to 100 maximum users. If the user has more events that the user is interested in, this process repeats for up to fifty events that the user is interested in. The algorithm compiles a resultant list of potential matches ordered by a points system. The app displays a paginated list of the top potential matches determined by the points system. The match requester may choose to initiate a meeting with a maximum number of matches through messaging or other communication means.

Events are categorized under one or more categories such as “party,” “concerts,” “hiking trips,” etc. For each of these categories the database adds a new category to the user's profile as a method of within-system data collection on the user. The user can have a maximum numbers of categories with the highest points to the top categories. These categories are used to determine points for potential matches. The user can also list passions in the user's profile to determine points for potential matches.

Although the invention has been explained in relation to its preferred embodiment, it is to be understood that many other possible modifications and variations can be made without departing from the spirit and scope of the invention.

What is claimed is:

1. A method for viewing and curating a plurality of in-person social events, the method comprising the steps of:
(A) providing a plurality of user accounts managed by at least one remote server, wherein each user account is associated with a corresponding personal computing (PC) device, and wherein the plurality of user accounts may be designated as at least one of a participant account and an event creator account;
(B) providing a plurality of swipe cards managed by the remote server, wherein each of the plurality of swipe cards includes photos and/or videos with a description of an in-person event created by at least one event creator account;
(C) enabling each of the plurality of user accounts to browse through the plurality of swipe cards included on a browse page using the corresponding PC device;
(D) displaying a plurality of categories on the browse page for each of the plurality of user accounts to select from managed by the remote server, wherein each of the plurality of categories provides a list of events matching to a corresponding category, wherein the corresponding category is from the plurality of categories;
(E) providing a plurality of action command buttons for each of the plurality of swipe cards, through the remote server, wherein the plurality of action command buttons includes at least one of an interested button, an invite button, an attending button, an accept invite button, and a reject invite button;
(F) enabling the plurality of user accounts to select at least one of the action command buttons to a preferred event, through the corresponding PC device, wherein the preferred event is from the plurality of swipe cards;
(G) generating, through the remote server, a personal collection of events page for each of the plurality of user accounts for user review and management of events specifically related to the user;
(H) providing a social page through the remote server, wherein the social page displays events suggested to a corresponding user account and enables social interaction, wherein the corresponding user account is from the plurality of user accounts;
(I) enabling each of the plurality of user accounts to create a personal profile page through the corresponding PC device; and
(J) enabling each of the plurality of user accounts to post at least one event through the corresponding PC device.

2. The method as claimed in claim 1, comprising the steps of:
receiving a notification command on the corresponding PC device of a corresponding user, wherein the corresponding user received an invitation to a corresponding event; and
providing a notification symbol on an associated swipe card of the corresponding event.

3. The method as claimed in claim 2, wherein the notification command is a pop-up list of events that the corresponding user account is invited to.

4. The method as claimed in claim 2, wherein the notification symbol reveals an accept invite button and a decline invite button associated with the notification symbol.

5. The method as claimed in claim 1 comprising the steps of:
selecting a singular swipe card from the plurality of swipe cards through the corresponding PC device, to display a pop-up event page; and
enabling the user account to mute the sound of a video in the pop-up event page; and
enabling the user account to post pictures and videos of the corresponding event in the pop-up event page.

6. The method as claimed in claim 1 comprising the steps of:
entering, using the corresponding PC device, a preferred location of an event and tapping a search button on the display device;
entering, using the corresponding PC device, a preferred time of an event and tapping the search button on the display device;
entering, using the corresponding PC device, a preferred rate of entry of an event, and tapping the search button on the display device; and
relaying a filter collection view of events on the corresponding PC device, based on search results.

7. The method as claimed in claim 1, wherein browsing through the browse page includes a map-based interface.

8. The method as claimed in claim 1, comprising the steps of:
enabling the plurality of user accounts to generate the plurality of categories through the corresponding PC devices;
displaying the plurality of categories while browsing through the browse page, based on popularity, location, and preferences pertinent to a corresponding user account, wherein the corresponding user account is from the plurality of user accounts; and
tapping, using the corresponding PC device on a preferred category from the plurality of categories to display events related to the preferred category;

9. The method as claimed in claim 1 comprising the steps of:
tapping on the interested button using the corresponding PC device, and sending a command to the remote server expressing interest in a corresponding event;
revealing an invite button on the corresponding PC device, upon tapping of the interest button on the corresponding event, wherein the corresponding event is from the plurality of events;
tapping on the invite button and sending out invitations to the corresponding event, through the corresponding PC device; and
tapping on the attending button using the corresponding PC device, to reserve a spot at the corresponding event.

10. The method as claimed in claim 1, wherein the browse page includes a recommended section.

11. The method as claimed in claim 1, wherein a scope bar is provided on the personal collection of events page, to differentiate between events.

12. The method as claimed in claim 1, comprising the steps of:
enabling the plurality of user accounts to search for event creator accounts and participant accounts through the social page;
enabling the plurality of user accounts to befriend a first group of preferred user accounts from the plurality of user accounts, through the social page with the corresponding PC device;
enabling the plurality of user accounts to follow a second group of preferred user accounts from the plurality of user accounts, through the social page with the corresponding PC device; and
displaying a collection of events through the social page in which each event from the collection of events corresponds to an event that at least one of the first group of preferred user accounts and the second group of user accounts are interested in or attending.

13. The method as claimed in claim 1 comprising the steps of:
prompting each of the plurality of user accounts to press a match button, to enable execution of a matching algorithm, wherein the matching algorithm searches for user accounts from the plurality of user accounts, with similar interests and interests in similar events; and
notifying each of the plurality of user accounts about a plurality of matching accounts through the matching algorithm, wherein the plurality of matching accounts is from the plurality of user accounts.

14. The method as claim in claim 1, wherein the plurality of user accounts displays highlights of posted events through the personal profile page, wherein highlights includes photos and videos that the corresponding user account has added in the personal profile page.

15. The method as claimed in claim 1 comprising the steps of:
prompting the event creator account to post an event with the corresponding PC device;
prompting the event creator account to categorize the posted event into a labeled category with the corresponding PC device, wherein the posted event is stored in a remote server database;
transferring the labeled category into the plurality of categories, wherein each of the plurality of categories is user generated; and
generating an updated personalized collection of event postings for each of the user accounts through the remote server, wherein the updated personalized collection of event postings is based on the remote server database.

16. A method for viewing and curating a plurality of in-person social events, the method comprising the steps of:
(A) providing a plurality of user accounts managed by at least one remote server, wherein each user account is associated with a corresponding personal computing (PC) device, and wherein the plurality of user accounts may be designated as at least one of a participant account and an event creator account;
(B) providing a plurality of swipe cards managed by the remote server, wherein each of the plurality of swipe cards includes photos and/or videos with a description of an in-person event created by at least one event creator account;
(C) enabling each of the plurality of user accounts to browse through the plurality of swipe cards included on a browse page using the corresponding PC device, wherein browsing includes a map-based interface;
(D) displaying a plurality of categories on the browse page for each of the plurality of user accounts to select from managed by the remote server, wherein each of the plurality of categories provides a list of events matching to a corresponding category, wherein the corresponding category is from the plurality of categories;
(E) providing a plurality of action command buttons for each of the plurality of swipe cards, through the remote server, wherein the plurality of action command buttons includes at least one of an interested button, an invite button, an attending button, an accept invite button, and a reject invite button;
(F) enabling the plurality of user accounts to select at least one of the action command buttons to a preferred event, through the corresponding PC device, wherein the preferred event is from the plurality of swipe cards;
(G) generating, through the remote server, a personal collection of events page for each of the plurality of user accounts for user review and management of events specifically related to the user;
(H) providing a social page through the remote server, wherein the social page displays events suggested to a corresponding user account and enables social interaction, wherein the corresponding user account is from the plurality of user accounts;
(I) enabling each of the plurality of user accounts to create a personal profile page through the corresponding PC device; and
(J) enabling each of the plurality of user accounts to post at least one event through the corresponding PC device.

17. The method as claimed in claim 16 comprising the steps of:
tapping on the interested button using the corresponding PC device, and sending a command to the remote server expressing interest in a corresponding event;
revealing an invite button on the corresponding PC device, upon tapping of the interest button on the corresponding event, wherein the corresponding event is from the plurality of events;
tapping on the invite button and sending out invitations to the corresponding event, through the corresponding PC device; and
tapping on the attending button using the corresponding PC device, to reserve a spot at the corresponding event.

18. The method as claimed in claim 16, comprising the steps of:
enabling the plurality of user accounts to search for event creator accounts and participant accounts through the social page;
enabling the plurality of user accounts to befriend a first group of preferred user accounts from the plurality of user accounts, through the social page with the corresponding PC device;
enabling the plurality of user accounts to follow a second group of preferred user accounts from the plurality of user accounts, through the social page with the corresponding PC device; and
displaying a collection of events through the social page in which each event from the collection of events corresponds to an event that at least one of the first group of preferred user accounts and the second group of user accounts are interested in or attending.

19. The method as claimed in claim 16, comprising the steps of:
prompting each of the plurality of user accounts to press a match button, to enable execution of a matching algorithm, wherein the matching algorithm searches for user accounts from the plurality of user accounts, with similar interests and interests in similar events; and
notifying each of the plurality of user accounts about a plurality of matching accounts through the matching algorithm, wherein the plurality of matching accounts is from the plurality of user accounts.

20. The method as claimed in claim 16 comprising the steps of:
prompting the event creator account to post an event with the corresponding PC device;
prompting the event creator account to categorize the posted event into a labeled category with the corresponding PC device, wherein the posted event is stored in a remote server database;
transferring the labeled category into the plurality of categories, wherein each of the plurality of categories is user generated; and
generating an updated personalized collection of event postings for each of the user accounts through the remote server, wherein the updated personalized collection of event postings is based on the remote server database.
